(19) United States
(12) Patent Application Publication
(10) Pub. No.: US 2017/0132057 A1
(43) Pub. Date: May 11, 2017

(54) FULL DUPLEX DISTRIBUTED TELEMETRY SYSTEM

(71) Applicant: Microsoft Technology Licensing, LLC, Redmond, WA (US)

(72) Inventors: Dejun Zhang, Redmond, WA (US); Bin Wang, Bellevue, WA (US); Robert Yu Zhu, Bellevue, WA (US); Ying Chin, Bellevue, WA (US); Pengxiang Zhao, Bellevue, WA (US); Satyendra Bahadur, Yarrow Point, WA (US)

(73) Assignee: Microsoft Technology Licensing, LLC

(21) Appl. No.: 14/933,925

(22) Filed: Nov. 5, 2015

(51) Int. Cl. G06F 11/07

(52) U.S. Cl. CPC G06F 11/079; G06F 11/0709; G06F 11/0751; G06F 11/0787

(57) ABSTRACT

Embodiments relate to a device ecosystem in which devices collect and forward failure data to a control system that collects and analyzes the failure data. The devices record, categorize, transform, and report failure data to the control system. Failures on a device can be counted and also correlated over time with tracked changes in state of the device (e.g., in use, active, powered on). Different types of Mean Time To Failure (MTTF) statistics are efficiently computed in an ongoing manner. A pool of statistical failure data pushed by devices can be used by the control system to select devices from which to pull detailed failure data.

### BACKGROUND

Devices that run software fail at varying rates over time. Failures are unavoidable occurrences that often stem from the inherent imperfectability of complex hardware and software systems. It has been a longstanding practice to identify software failures by storing records of failures when they occur on devices, and then collecting those failure records in a central repository for analysis and issue identification. However, this approach has recently become less effective and less convenient for improving the experiences of device users. Software developers take advantage of increasing hardware capabilities and write code to capture larger amounts of failure data with finer granularity. Moreover, devices with high levels of network connectivity may be subjected to frequent updates, software installations, and configuration changes, which tends to increase software failure rates.

These factors have led to a proliferation of failure data, which can cause problems. Increasing amounts of failure data require additional network bandwidth and power to transmit from a device to a collection service. For resource-limited devices such as mobile phones, this can have varying degrees of impact on battery life, network usage fees, available processor cycles, etc. In addition, increasing volume, granularity, and frequency of debugging data received by a software provider's collection system can make it difficult to prioritize issues that are occurring on devices. It has not previously been appreciated that the expansion of failure data and corresponding range of issues being reported makes it difficult to identify the issues that have the greatest impact on the actual usability of devices.

Described below are techniques related to reducing amounts of failure data while improving the content of the failure data to enable rapid identification of issues that are having the greatest individual or collective impact on users.

### SUMMARY

The following summary is included only to introduce some concepts discussed in the Detailed Description below. This summary is not comprehensive and is not intended to delineate the scope of the claimed subject matter, which is set forth by the claims presented at the end.

Embodiments relate to a device ecosystem in which devices collect and forward failure data to a control system that collects and analyzes the failure data. The devices record, categorize, transform, and report failure data to the control system. Failures on a device can be counted and also correlated over time with tracked changes in state of the device (e.g., in use, active, powered on). Different types of Mean Time To Failure (MTTF) statistics are efficiently computed in an ongoing manner. A pool of statistical failure data pushed by devices can be used by the control system to select devices from which to pull detailed failure data.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows an example of a software ecosystem.

FIG. 2 shows exchanges between a device and a control system.

FIG. 3 shows details of agent software running on a device.

FIG. 4 shows processes performed by an observation logger and a report generator.

FIG. 5 shows example observations that might be recorded in an observation log for two respective failure types.

FIG. 6 shows an example of report entries in a report log.

FIG. 7 shows an example of how event types are mapped to failure types or categories.

FIG. 8 shows a list of examples of failure types or categories.

FIG. 9 shows a baseline MTTF calculation.

FIG. 10 shows an example of MTTF calculated using an uptime method.

FIG. 11 shows an example of calculating MTTF using an active-use method.

FIG. 12 shows how the control system accumulates failure reports for a device and uses the failure reports to control requests to pull additional data from the device.

FIG. 13 shows an example of how two arbitrary consecutive periods of MTTF statistics can be combined to compute total MTTF values for the total period of time that spans those two periods.

FIG. 14 shows an example of a schema that can be used for periods of any time scale.

FIG. 15 shows an MTTF distribution curve for MTTF values calculated for a given set of devices.

FIG. 16 shows other uses of the control system.

FIG. 17 shows an example of a user interface.

FIG. 18 shows another user interface.

FIG. 19 shows details of a computing device on which embodiments described herein may be implemented.

### DETAILED DESCRIPTION

Embodiments discussed below relate to improving failure reporting and issue analysis. Discussion will begin with an overview of a device ecosystem in which devices collect and forward failure data to a control system that collects and analyzes the failure data. Covered next will be software embodiments to run on a device to record, transform, and report failure data. Examples of categories of failures and details of how related failure data can be derived and summarized are then discussed. This is followed by explanation of types of failure statistics and how they can be efficiently computed and maintained over potentially long periods of time. Described next are techniques to capture and incorporate, into failure data, data about device state that can relate failure issues to likelihoods or degrees of negative effects on users. Finally, central collection and employment of failure data is described, including how a large pool of statistical failure data pushed by devices can inform how a control system select devices from which to pull detailed failure data.

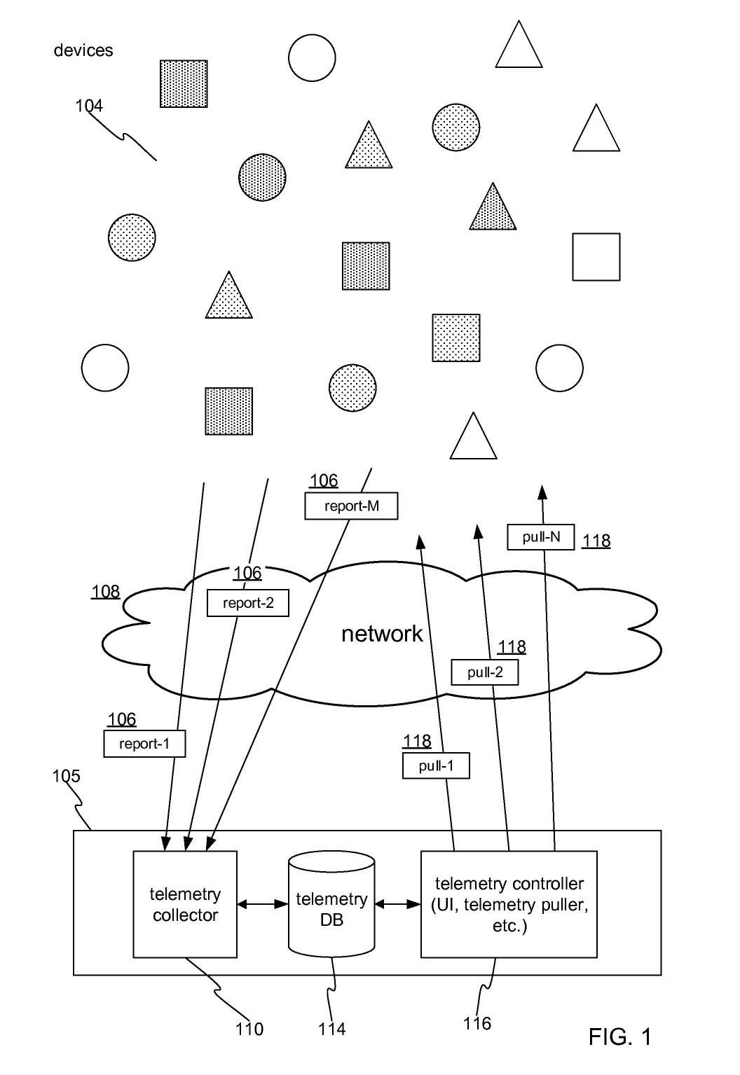

FIG. 1 shows an example of a software ecosystem. Various devices 104 have some software commonality, such as a same application or operating system. The shapes of the graphics representing the devices 104 portray different types of processors, such as ARM, x86, PowerPC™, Apple A4 or A5 ™, Snapdragon™, or others. The shading of the graphics representing the devices 104 indicates different operating system types or versions, for example, Ubuntu™, Apple iOS™, Apple OS X™, Microsoft Windows™, and Android™. The devices 104 may be any type of device with communication capability, processing hardware, and storage hardware working in conjunction therewith. Gaming consoles, cellular telephones, networked appliances, notebook computers, server computers, set-top boxes, autonomous sensors, tablets, or other types of devices with communication and computing capabilities are all examples of devices 104, as referred to herein.

A telemetry framework is implemented at the devices 104 and at a control system 105. Telemetry instrumentation on the devices 104 collects failure data and pushes failure reports 106 across a network 108 to a telemetry collection service 110 of the control system 105. The control system 105 can be implemented as software running on one or more server devices. The collection service 110 receives the failure reports 106, parses them for syntactic correctness, extracts the failure data, and stores their contents in a telemetry database 114. The collection failure reports 106 might be structured documents and the collection service 110 can be implemented as an HTTPS (hypertext transfer protocol) server servicing file upload requests or HTTP posts. Techniques for reporting and collecting diagnostic data are known and details thereof may be found elsewhere. The control system 105 may also have a telemetry controller 116. As described further below, the telemetry controller 116 uses the failure data in the telemetry database 114 to select devices for acquisition of detailed failure data and sends pull requests 118 to those devices.

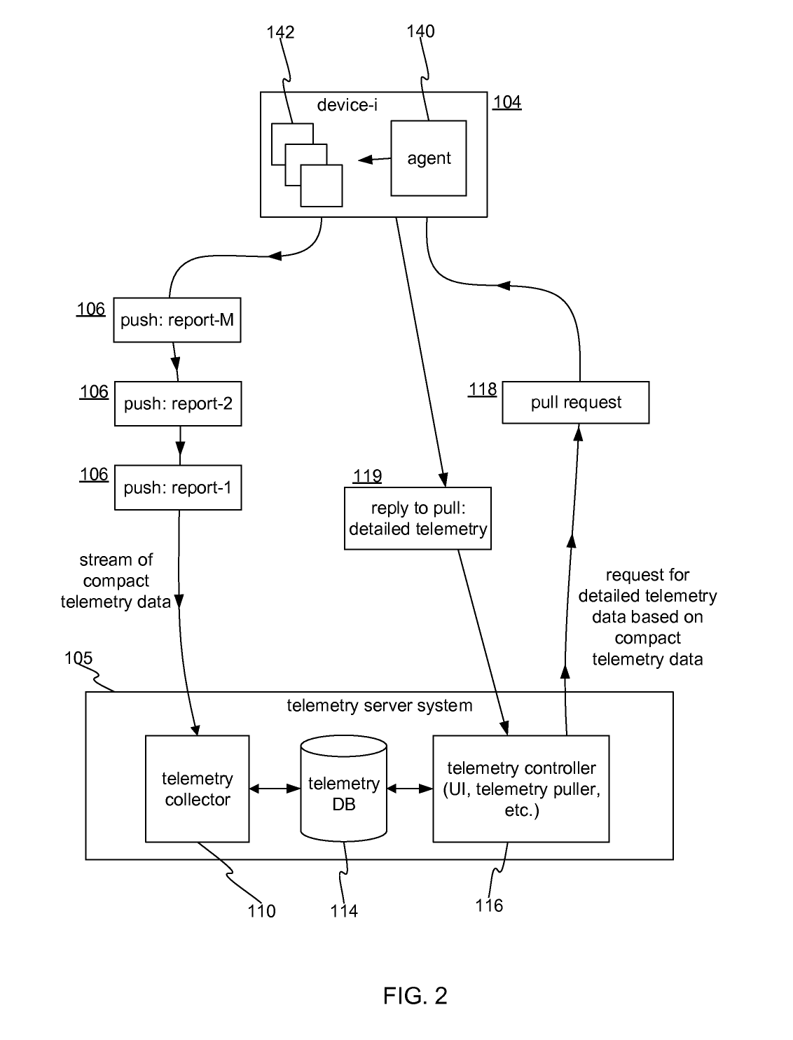

FIG. 2 shows exchanges between a device 104 and the control system 105. The device 104 includes failure reporting software such as agent software 140. The agent software 140 monitors failure reporting mechanisms or logs on the device 104 to generate failure logs 142. Content of the failure logs 142 serves as a base of failure statistics (failure data) that are regularly statistically aggregated and sent in the failure reports 106. The agent software 140 also collects time computation information which is incorporated into the failure data, as explained later.

The telemetry collector 110 stores the device's failure data into the telemetry database 114, which is used by the telemetry controller 116. The telemetry controller 116 queries the telemetry database 114 and obtains the device's failure data. If the failure data indicates a sufficient impairment of the device 104 or usability thereof, the telemetry controller 116 transmits a pull request 118. The device 104 responds to the pull request 118 by transmitting detailed failure data 119 or debugging data to the telemetry controller 116 or another collection point such as a debugging system.

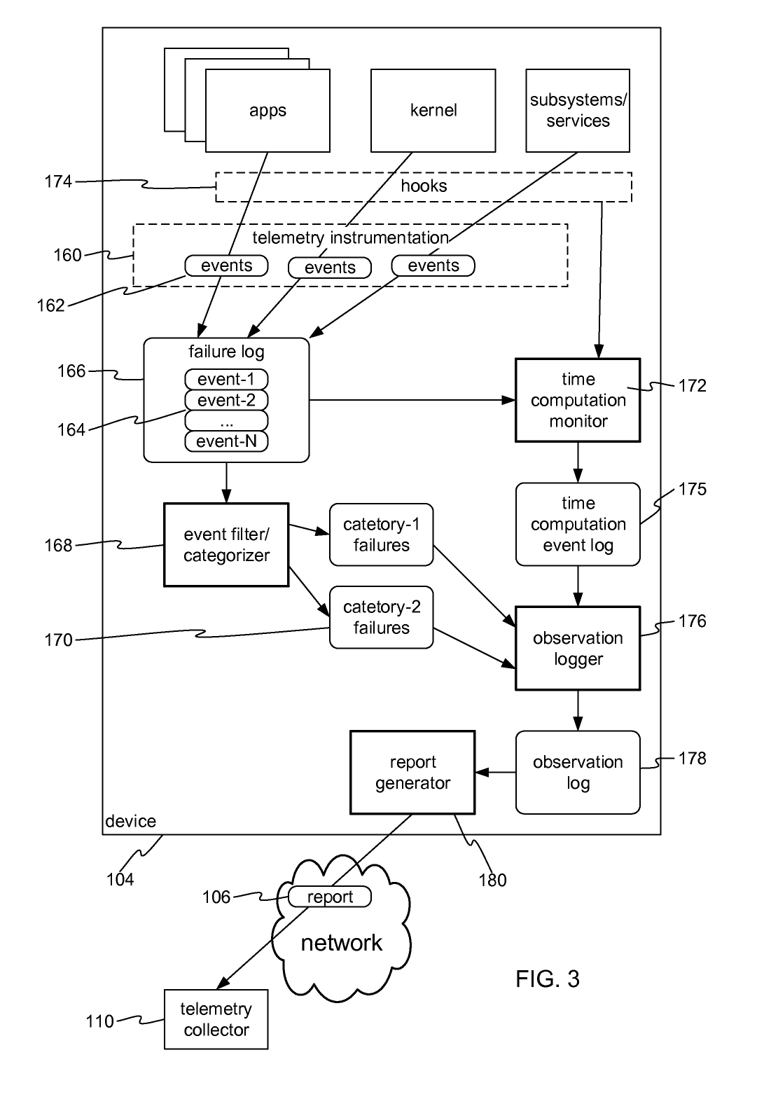

FIG. 3 shows details of the agent software 140 running on a device 104. Any software executing on the device 104 can make use of telemetry instrumentation 160 on the device 104 to recognize and capture failure events 162. The software that can generate failure events 162 might be application software, operating system software such as a kernel or kernel-mode code, subsystems or system services, background user-mode software, or other software. The telemetry instrumentation 160 can be a combination of: libraries called in the software, monitoring software that intercepts interrupts, and/or a system service called by software to report an error, etc. Failure events 162 need not be recognized and recorded when they occur. For example, software beginning to execute might check for signs that it previously exited with an error condition and then generate a failure event.

The failure events 162 are recorded as failure records 164 in a failure log 166. Failure reporting and recording can be implemented in known ways. However, the failure log 166 can possible contain a large number of failure records 164 covering a wide range of issues of varying significance to the user. Consequently, simply sending the failure log 166 to the control system 105 would be inefficient and of limited value. To improve the quality and information density of the failure data that is ultimately sent in a failure report 106, several techniques are used on the device 104.

To filter and condense the failure records 164, an event filter 168 is configured to recognize different categories or types of failure records 164, determine which failure category they are associated with, and store them (or indications thereof such as timestamps and failure-type identifiers) in corresponding failure logs 170. As an example, consider an application generating a first failure record that identifies an internal logic error and a second failure record that indicates an erroneous termination of the application. Perhaps a system service fails and a corresponding failure record is generated. The event filter 168 might: skip the first failure record, identify the second failure record as a first category of failure and store the first failure record (or a portion of its information) in a first failure log 170, and recognize that the third failure record belongs to a second category of failures and store the second failure record in a second failure log 170. The result is that the failure logs 170 accumulate select categories of failure records. The failure records may include typical diagnostic information such as timestamps, identification of the source of the failure, the type of failure or failure event, state of the device or software thereon when the failure occurred, etc.

As noted above, the agent software also collects time computation information that can be incorporated into the failure data to improve the meaningfulness of statistical calculations such as mean time to failure (MTTF). As observed only by the inventors, not all recorded failures on a device are failures that affect a user of the device. As further observed by the inventors, some failures are unlikely to be noticed by a user because they occur while the failing software is running in the background or is not visible to the user. Moreover, as first observed by the inventors, some failures occur while a device is powered on but is not being actively used and those failures are therefore less likely to have affected the user. As further observed by the inventors, the amount of time that a device is powered on and/or in active use can significantly affect the predictive value of failure statistics such as MTTF. By capturing the right type of data, user-affecting failure statistics can be computed. That is to say, a statistic such as “mean time to user-noticeable failure” or the like can be computed.

To that end, a time computation monitor 172 logs the times of various types of occurrences on the device 104 or of various changes of a state of the device 104. Time events can be obtained from any source, such as hooks 174 into the kernel, applications, a windowing system, system services, the failure log 166, other logs such as boot logs, and so forth. In one embodiment, the time computation monitor 172 captures boundaries of types of time periods such as uptime and active use time. Beginnings of uptime periods are bounded by any indications of the device being powered on and/or booted. Ends of uptime periods can be identified from information corresponding to: the device being powered off by the user, the operating system being shut down or restarted cleanly, a type of failure that is usually accompanied by a restart of a device, any arbitrary last timestamp in any log that precedes a significant time without timestamps, etc.

In a similar vein, the time computation monitor 172 can capture boundaries of periods of active use of the device. A period of active use can be identified by recognizing when certain types of activities are “live” or ongoing. Because activities that are monitored can be concurrent (overlap), activity periods (periods when any activity type occurs) can be recognized by (i) identifying a start of an activity period by detecting when there is currently no activity in progress when an activity of any type begins, and (ii) identifying the end of that activity period by detecting when there ceases to be an activity of any type in progress. In other words, a period of activity corresponds to a period of time during which there was continuously at least one activity in progress; a long activity period can be defined by sequences of perhaps short overlapping activities. Time periods can be marked by start times and end times.

Following are some examples of occurrences that can be used to identify different types of activities, any mix of which can indicate a period of active use:

(i) backlight is powered on, then

(ii) backlight is powered off;

(i) speaker starts playing for >5 seconds, then

(ii) speaker stops playing audio for >5 seconds;

(i) headphone jack starts playing for >5 seconds, then

(ii) headphone jack stops playing for >5 seconds;

(i) bluetooth radio starts transmitting a phone call, music or other persistent audio signal for >5 seconds, then

(ii) bluetooth radio stops transmitting a phone call, music or other persistent audio signal for >5 seconds;

(i) an application starts running under the lock screen, then

(ii) an application stops running under the lock screen.

To summarize, the time computation monitor 172 records one or more types of time-computation periods (e.g., periods of being powered up, periods of active use, etc.) by storing corresponding start/end timestamps for different types of time-computation periods in a time computation event log 175.

Returning to FIG. 3, an observation logger 176 periodically reads the time computation event log 175 and the failure logs 170 to compute failure statistics for sequential periods of time (observation periods). For example, every two hours, the observation logger 176 may record to an observation log 178 a total amount of each time-computation type (e.g., total active time and uptime) that occurred during that time period. In addition, for each failure type (failure category in a corresponding failure log), the observation logger 176 counts and records the number of failure events of that type that occurred during the time period being observed (e.g., the last two hours). The observation logger 176 also, for each failure type, computes and records the amount of time since the last occurrence—before the current observation period—of an event of that type. The purpose of this last type of data will become apparent later.

Finally, a report generator 180 periodically (e.g., every 24 hours) uses the observation log 178 to add up the statistics for each failure type during the most recent report period (the time since a last failure report was generated).

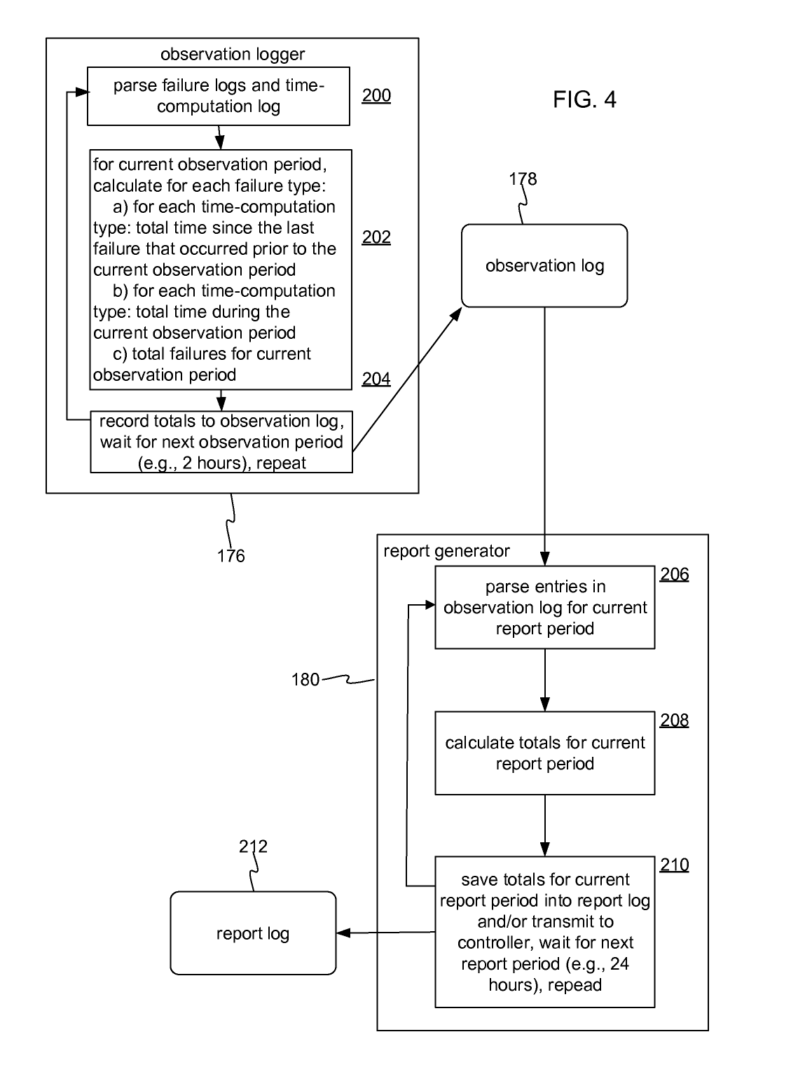

FIG. 4 shows processes performed by the observation logger 176 and the report generator 180. At step 200, for a current observation period, the observation logger parses the failure logs 170 and the time computation log 174 to obtain time and failure data for the current observation period. At step 202, the obtained time and failure data is used to compute failure counts and time durations for the current observation period. There may be different durations and failure counts for respective different failure types. For the current observation period (a current iteration of the observation logger), an observation for each failure type is computed in turn as follows (with total amount of time being treated as one of time-computation types):
(a) for each time-computation type: compute total amount of time prior to the last iteration of the observation logger (i.e., amount of time from (i) the last failure that immediately preceded the current observation period up to (ii) the beginning of the current observation period); and
(b) for each time-computation type, compute: the total amount for the current observation period; and
(c) count the number of events/failures recorded in the current failure type's failure log 170 since the last observation period (since the last iteration of the observation logger, e.g., ˜2 hours ago).

Incremental observations can performed by keeping track of which portions of the time and failure logs have not been processed. Each time the observation logger executes, it consumes the portions of the logs that have not been processed, and then updates the logs accordingly.

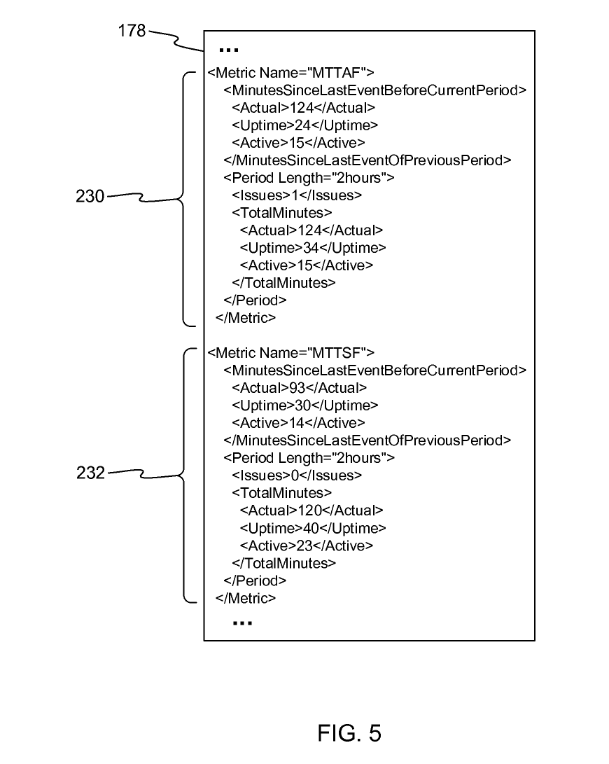

FIG. 5 shows example observations 230, 232 that might be recorded in the observation log 178 for two respective failure types. The upper example observation 230 is for one observation period and one failure type (MUSE—Mean Time To Application Failure), and the lower example observation 232 is for another failure type (MTTSF—Mean Time To System Failure) for the same observation period. In one embodiment, there may be delays between capturing observations of the failure types. For example, there might be intentional delays to spread the load of the observation logger. Moreover, if there are many failure types, time computations will be affected by passage of time during the processing of the failure types; the last failure type observation might be computed many minutes after the first.

Returning to FIG. 4, the observation logger waits until the next observation period ends (e.g., two hours), and then repeats. When the report generator 180 executes, there will be multiple entries (observations) in the observation log, for each failure type. For example, if the report generator executes or iterates every twenty four hours, there will be 24 observations for each failure type. The observation log 178 contains the duration and failure data for each failure type. Because observations are logged in time increments that may be small relative to a reporting cycle, the computational load is spread, since the pre-computed observations can be used to quickly compute similar statistics for the relatively longer reporting period.

The report generator generates a report observation for each failure type, each of which is stored in a report log 212, file, telemetry report package, etc. Conceptually, the report generator computes the same types of statistics that the observation logger computes, but for longer intervals, and by combining the statistics in the observation log rather than by parsing failure logs 170 and the time computation event log 175. Specifically, at step 206, the report generator generates a report observation by obtaining and combining the observations in the observation log for each failure type, for the current reporting cycle (e.g., for all observations that have not yet reported). That is, a report observation includes a report entry—a set of failure counts and time durations—for each failure type. In addition to periodically computing the report observations, the report generator keeps cumulative statistics for each failure type. At step 208, those cumulative statistics are updated per the new report observation, and at step 210 the new observation report, with cumulative statistics, is stored in the report log 212 or some other container such as a report 106 for transmission to the telemetry collector.

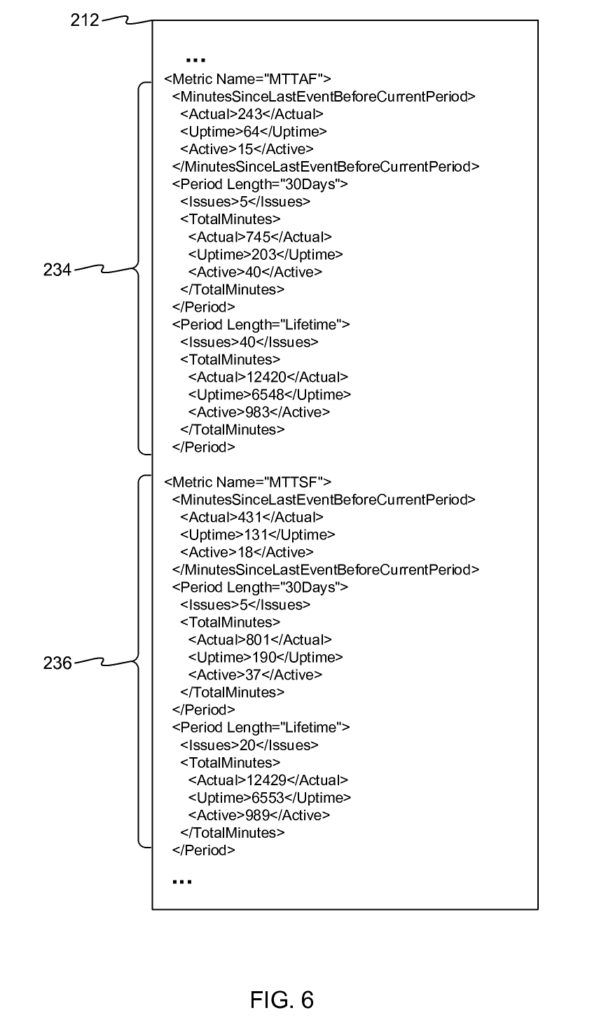

FIG. 6 shows an example of failure entries 234, 236 in the report log 212. The content is somewhat the same as the observation log, but with the addition of a cumulative (e.g., lifetime) statistic, that can be incrementally maintained in a straightforward manner. As explained further below, the report log contains sufficient information to compute mean time to failure (MTTF) statistics for a corresponding report period. Moreover, contents of a sequence of such reports can be combined by the control system to form the same kinds of statistics for longer time periods.

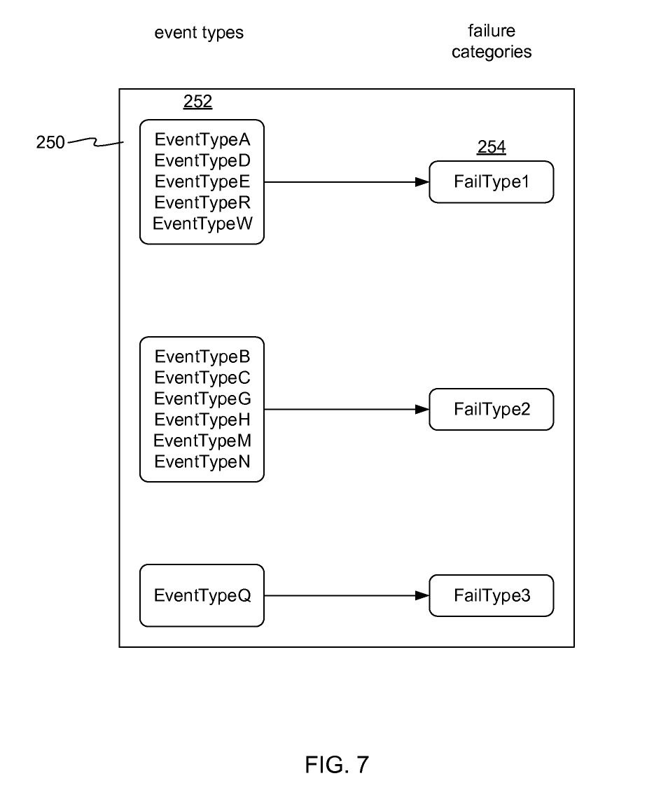

FIG. 7 shows an example of how event types are mapped to failure types or categories. The agent software running on a device, for instance the event filter 168, is coded to recognize different types of failure events as being associated with certain respective failure categories. The associations may be in the form of a table 250, which maps identities 252 of event record types to corresponding failure categories. Alternatively, the associations are implicitly implemented by the code of the event filter 168 or the like.

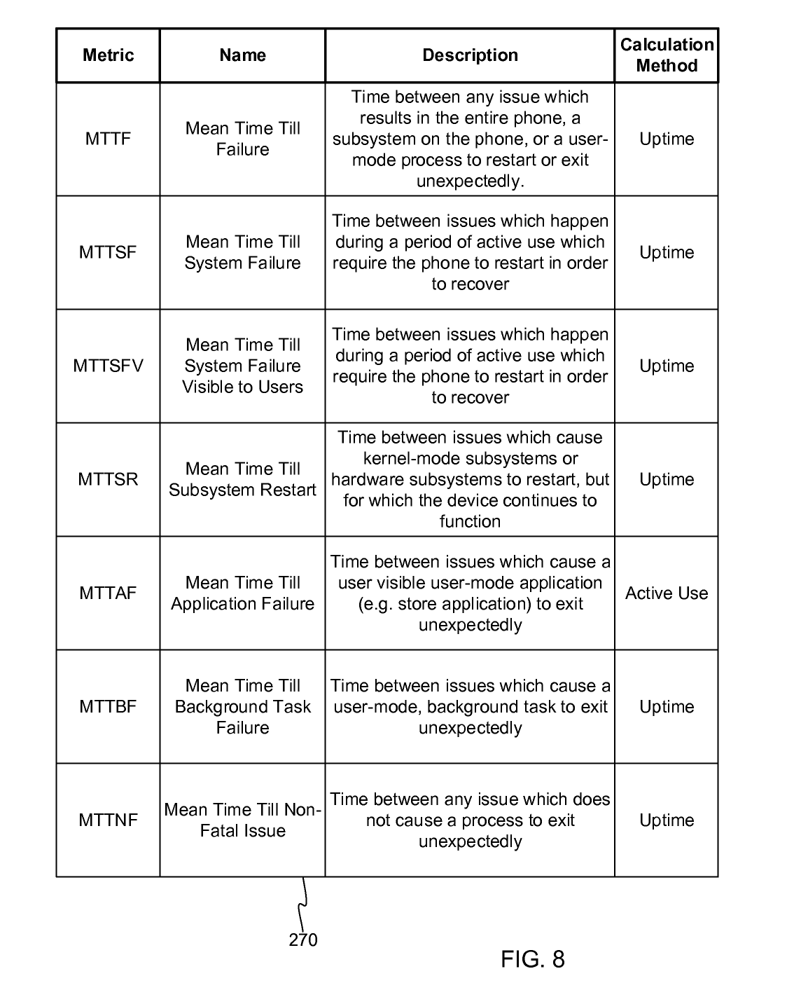

FIG. 8 shows a list 270 of examples of failure types or categories. FIG. 8 also indicates how the failure types can be calculated. As discussed further below, calculation of a given failure category for a given time period using the “Uptime” method is similar to computing a MTTF. However, instead of total time for the time period, total uptime for the period is used instead. Likewise, when an “Active Use” failure category is calculated for a given time period (a span of consecutive failure events), the total amount of active use time of the corresponding device for the given time period is used for the MTTF calculation.

In practice, each failure type will have a similar failure entry that is generated and reported by each execution of the report generator (see FIG. 6). Of course, details such as time periods for logging, observation capturing, time periods for reporting observations, the form and content of logs, failure types, observations and reports, and so forth, are not significant and can vary for different implementations. Of note, as will become more apparent, are features that relate to efficient generation and collection of information-dense failure data that can provide new ways of understanding and evaluating failures for individual devices as well as failures of a population of devices.

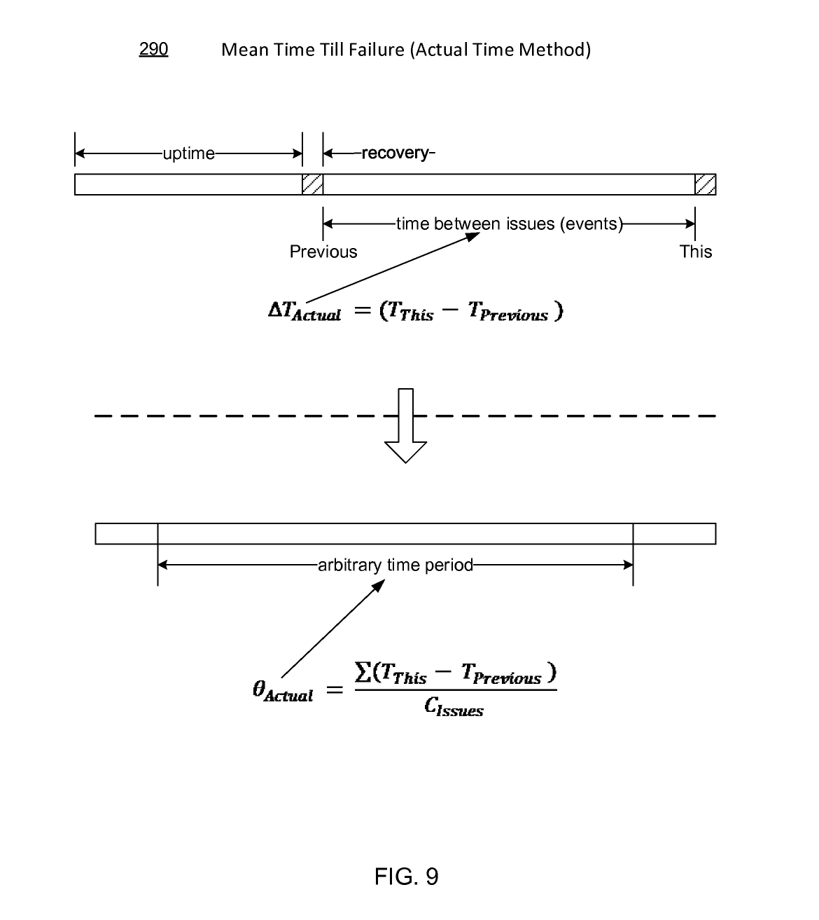

FIG. 9 shows a baseline MTTF calculation 290. Statistically, a single countable failure event corresponds to a time between recovery from a failure and occurrence of a next failure. However, for simplification, recovery time can be treated as zero. The failure counts discussed herein are counts of failure events. For an arbitrary period, such as an observation period, the MTTF will be the total of times between the failures of that period, divided by the number of failure events in that period, as shown in the lower part of FIG. 9. As noted, for simplification, it may be assumed that recovery time is effectively 0 seconds, since many devices recover from failures relatively quickly (even in the case of a reboot) in relation to device uptime. Removing this simplification would involve measuring a user's perceived downtime (as the user can do other tasks during report creation for all types of issues expect those which require a reboot). For purposes herein, recovery time is assumed to be relatively static after each incident and therefore measuring it does not meaningfully affect the results of an MTTF analysis. Nonetheless, references to “MTTF” herein will be considered to indicate both forms of MTTF.

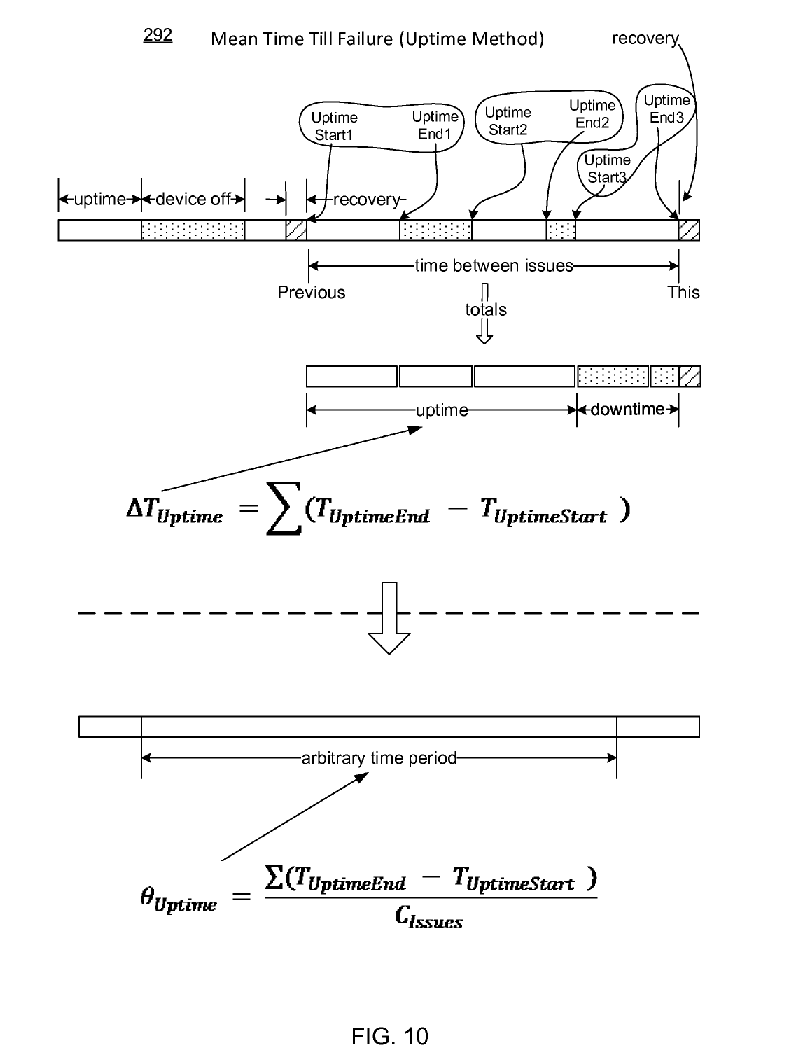

FIG. 10 shows an example 292 of MTTF calculated using the uptime method. Some devices, such as mobile phones and other battery powered devices can spend a non-trivial amount of time powered off. This period of time powered off, can artificially inflate a baseline MTTF calculation if a non-trivial set of a device population is powered off for a significant amount of time. As shown in the upper half of FIG. 10, if the uptime starts and uptime ends (downtimes) are known for a time between two failures or issues, then the total uptime for that failure event is the sum of the differences between start and end times. In addition, as shown in the lower half of FIG. 10, for any arbitrary time period with multiple issues or failures, the uptime-based MTTF is the sum of all of the uptimes in that time period divided by the number of failures. Note that uptime can be calculated in many ways, for instance by computing total downtime and subtracting from total time, etc.

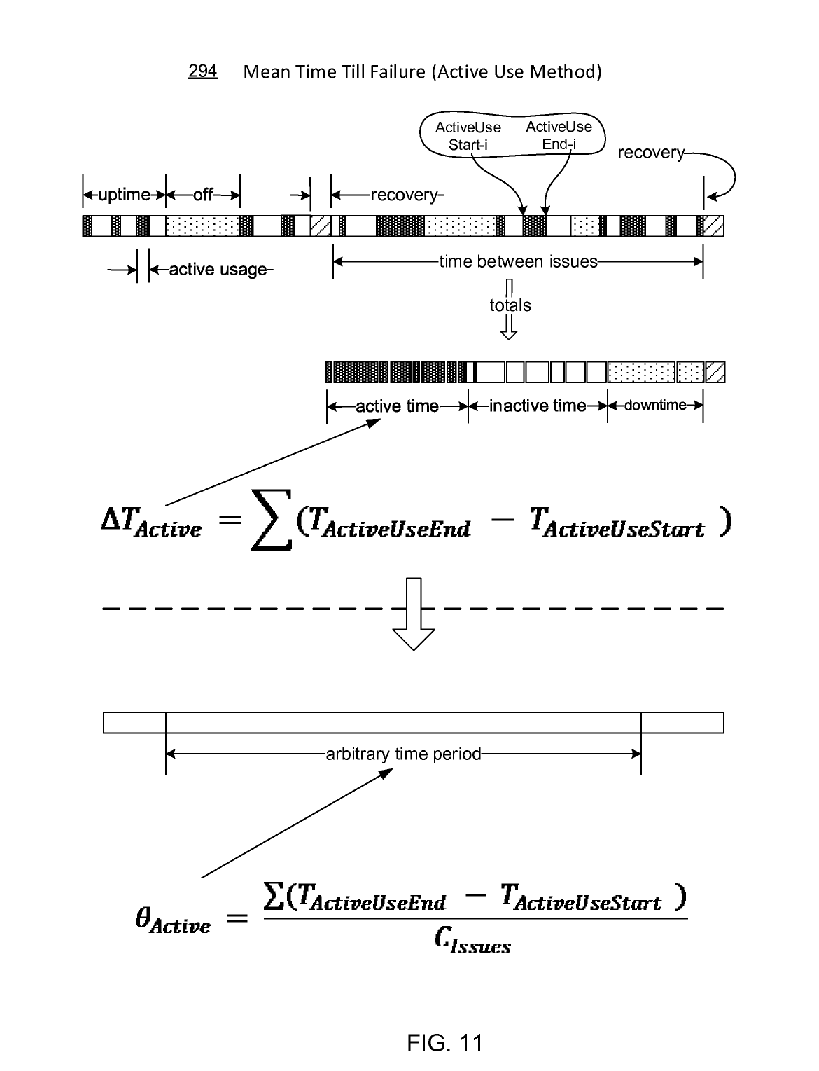

FIG. 11 shows an example 294 of calculating MTTF using an active-use method. Some computing devices spend a significant amount of their time not being actively used by a person. An MTTF calculated using only a device's uptime may be significantly different from an MTTF that is calculated in a way that correlates with a user using the device. Therefore, for a class of applications and situations, it can be useful to calculate the MTTF using the active-use time. With this calculation, the objection is to differentiate between time a device is doing something for a user (e.g. playing music) versus time the device is in the user's bag or pocket. Active use is a generic term for the notion that a device is doing ‘good and useful work’ that is noticeable to a user, including but not limited to: time the backlight it on, time when the backlight is off but the device is playing music, turn by turn directions, etc. As shown in the upper half of FIG. 11, if times when active uses begin and end are available, then active use time for a failure can be calculated as the sum of those periods, which can be conveniently computed. Moreover, for an arbitrary period, the active-use MTTF is the sum of all active use time for that period, divided by the number of issues (failure events) in that period, as shown at the bottom half of FIG. 11.

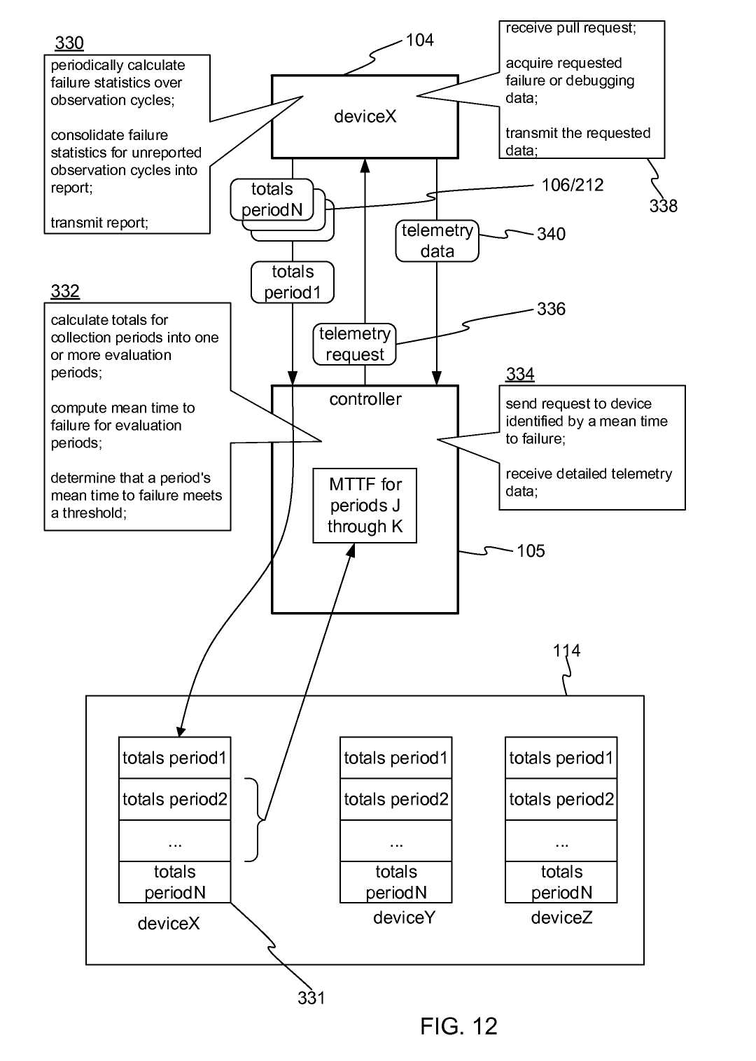

FIG. 12 shows how the control system accumulates failure reports for a device 104 and uses the failure reports to control requests to pull additional data from the device. The device 104 performs a process 330 of periodically calculating failure statistics from log files with timestamps for failures, beginnings and ends of active uses, beginnings and ends of uptime, etc. When a report is generated, the previously unreported observations are consolidated and transmitted. Over time, the device transmits reports 106/212, each covering the statistics that have accrued since the last time a report was generated, and the control system 105 stores the failure data in the reports into the database 114.

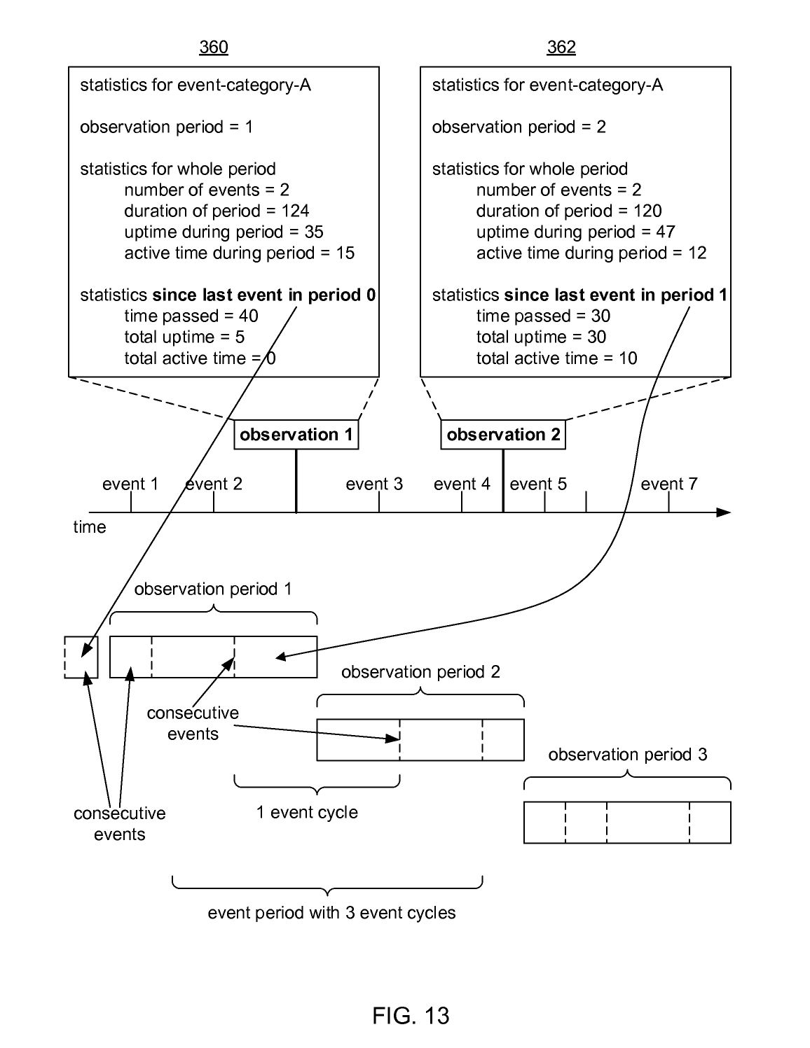

With the database 114 containing accumulated failure data 331 from respective devices for possibly long periods of time up to nearly current time, the control system 105 performs a process 332 for pulling additional failure or debugging data, if needed. The process 332 starts with an initial dataset from a set of one or more devices. The dataset can be filtered based on a variety of query conditions, such as device type, date or duration, software installed, software or operating system version, firmware, or any other data associated with devices. In one embodiment, rich device data can be linked in from other systems that track devices. In another embodiment, device information is provided in the failure reports 212. In any case, given a dataset of devices, the corresponding failure data for each device is obtained. Any of the MTTF calculations described herein are performed for each device using the corresponding data from the database 114 (how to combine sequences of statistics for a device is discussed below with reference to FIG. 13). When the MTTF calculations have been calculated for the devices in the dataset, each is evaluated against any kind of condition, such as a maximum MTTF value. MTTF values can be calculated for different times for a given device (e.g., a day, a month, and a year), and each time period's MTTF can be compared against a corresponding different threshold. In either case, devices that have been identified has having a qualifying MTTF value are selected by the control system 105 as targets for pulling additional information. For example, of identifiers of devices determined to be targets can be stored in a queue or list.

The control system 105 also has a process 334 for pulling detailed telemetry or failure data from the devices identified as having significant MTTF values. The process 334 can be an ongoing process that pulls data from any device that enters the queue. Any time process 332 is run, the process 334 will begin sending pull requests 336 to devices as they enter the queue, even while the process 332 is running. Alternatively, the process 334 can be a batch process that communicates with devices after process 332 has finished. The control system 105 sends a pull request 336 to a selected device via the network 108. The agent or telemetry software on the targeted device performs a process 338, which involves receiving the request 336, collecting the requested data such as debugging logs, binary crash dumps, crash reports, execution traces, or any other information on the device. The detailed telemetry data 340 is then returned to the control system 105 or another collection point such as a bug management system. In one embodiment, the telemetry data 340 can include information such as a failure log 170 for a failure category whose MTTF triggered the request 336 for additional telemetry data. The detailed telemetry data 340 can also be included in the next report that will be sent by the device.

As noted above, if statistics in reports from a device are stored as received, i.e., if the statistics of a device for each report (e.g., daily) are stored, MTTF statistics can be computed for arbitrary sequences of those time periods. For instance if the database 114 is storing N days' worth of statistics for a device, then an MTTF for an arbitrary period from day J to day K can be computed by combining the statistics of those days. Alternatively, the stored statistics can be consolidated into larger time units, such as weeks or months, which trades granularity for less storage use. The granularity of a device's statistics can be graduated, where granularity decreases with age; daily reports are stored for the last 30 days, which are later consolidated into weekly statistics for the last 6 months, which are later consolidated into monthly statistics for the last year, etc. When a new month arrives, for example, the weekly MTTF statistics for that month can be summed and MTTF values for that month can be calculated therefrom.

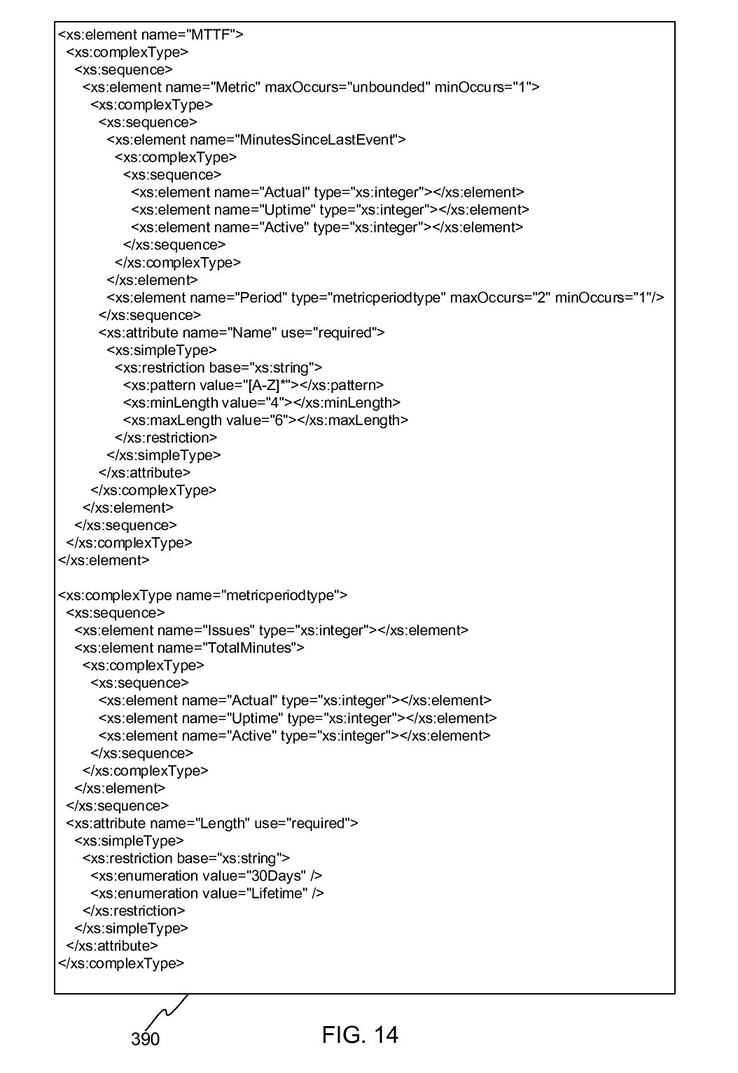

FIG. 13 shows an example of how two arbitrary consecutive periods of MTTF statistics 360, 362 can be combined to compute a total MTTF value for the total period of time that spans those two periods. The same approach can be used for combining observation periods (e.g., bi-hourly) to obtain a report period statistic (e.g., daily), or any other pairs of MTTF statistics such as statistics 360, 362 that correspond to consecutive time periods. In FIG. 13, suppose that observation period 1 and observation period 2 are to be consolidated. Generally, the “whole period” statistics 360 of each observation period are respectively added to get first respective new “whole period” totals for the new combined period; the number of events, the duration of each period, the uptime, active time, etc. of each period are respectively added. To account for an event cycle that wraps across two observation periods (i.e., from a last event in period 1 to a first event in period 2), the “since last event” statistics of the statistics 361 and 362 are also added to the respective new totals, and a new “since last event” for the combined period is refreshed. The same computation can be performed for any failure type. FIG. 14 shows an example of a schema 390 that can be used for periods of any time scale.

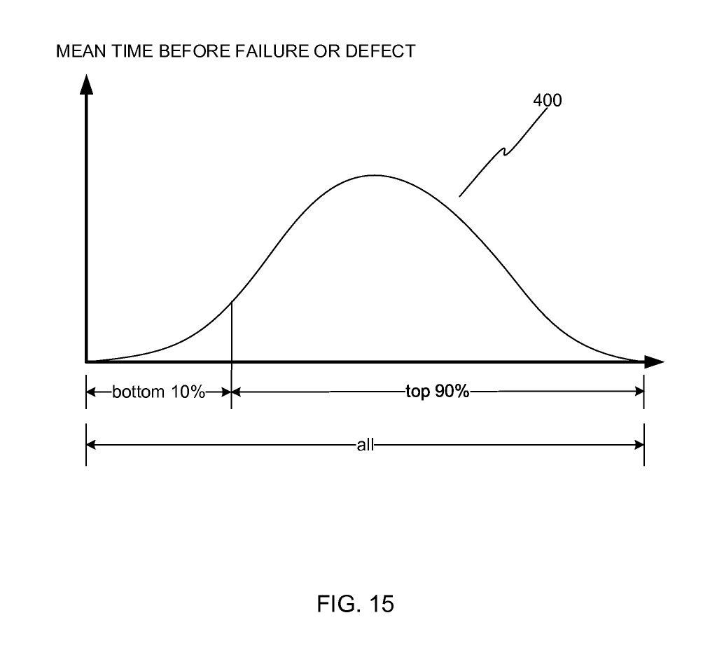

FIG. 15 shows an MTTF distribution curve 400 for MTTF values calculated for a given set of devices. For any point (x,y) on the curve, for the given set of devices, x is an MTTF value/range, and y is the number of devices whose MTTF value falls within the x (MTTF) value/range. In any such device set, there is a subset that is prone to a higher failure or defect rate. FIG. 15 shows where devices whose MTTF falls in the bottom 10% fall under the curve 400. Devices toward the left of the curve has a shorter mean time to failure and are the devices whose users have been having the worse experiences relative to the users of the other devices. The entire set provides a meaningful view of the best, worst, and average devices, and depending on the type MTTF value under evaluation, those understandings can closely reflect failures in terms of actual effect on users. The MTTF distribution among a set of devices can also be used to guide the process of selecting the devices from which additional diagnostic information will be pulled by the control system. For instance, the devices in the bottom 10% of the performance range can be pulled. Any number type of statistic derivable from the database 114 can be used to select devices for any type of mitigation or evaluation measures.

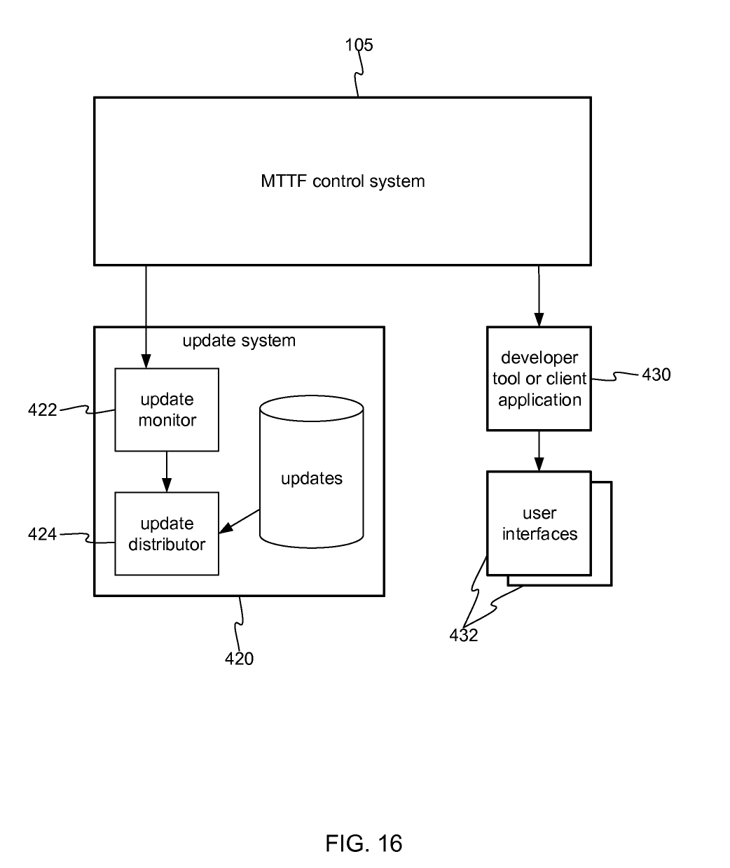

FIG. 16 shows other uses of the control system 105. The control system 105 or data output thereby can be used in other ways besides focusing pulling of diagnostic on the most needful devices. The failure information can also be used to inform updates of devices and to explore and visualize device failure data.

As discussed in U.S. patent application Ser. No. 14/676,214, a software updating system 420 can be constructed to use device telemetry data to inform which devices should receive which available operating system or application updates. The MTTF failure data and techniques for identifying problematic devices can be used to select which devices to update and/or which updates to use. The MTTF failure data of an individual device has (or can be linked to) update-relevant information about the device, for instant a device model or make, a software version, a type of CPU, an amount of memory, a type of cellular network, a cellular provider identity, or anything else.

An update monitor 422 receives an indication from the control system 105 that a particular device is to be targeted for possible updating. The update monitor 422 optionally passes update-selection data to a diagnostic system (not shown). The update-selection data might be any information about the device and/or the MTTF that triggered its selection, such as: identity of the device, the relevant MTTF type, a failure event type that contributed to the MTTF value, etc. Information about the device's configuration such as software version, model, operating system, etc., can be passed with the update-selection information, or such information can be obtained by the diagnostic system. The diagnostic system in turn determines a best update and informs the update monitor 422 accordingly. The update monitor 422 then informs an update distributor 424 of the identified device and the identified update, and the update monitor 422 causes the update to be sent to the device.

The system architecture is not important. What is significant is leveraging the MTTF data to automatically determine prioritize which devices should receive updates or to automatically determine which devices should be updated and/or which updates to apply to which devices. Instead of sending an update to a selected device, a notification can be provided to the device, or the identity of the update can be associated with the device, for example at a website or software distribution service regularly visited by the device. When a device visits a page of the website or communicates with the software distribution service, the device displays information about the update associated with the device.

The MTTF data can also be used by a tool 430 such as a client application. The tool 430 accesses the MTTF data from the control system 105. The tool 430 then displays user interfaces 432 for visualizing and exploring the MTTF data.

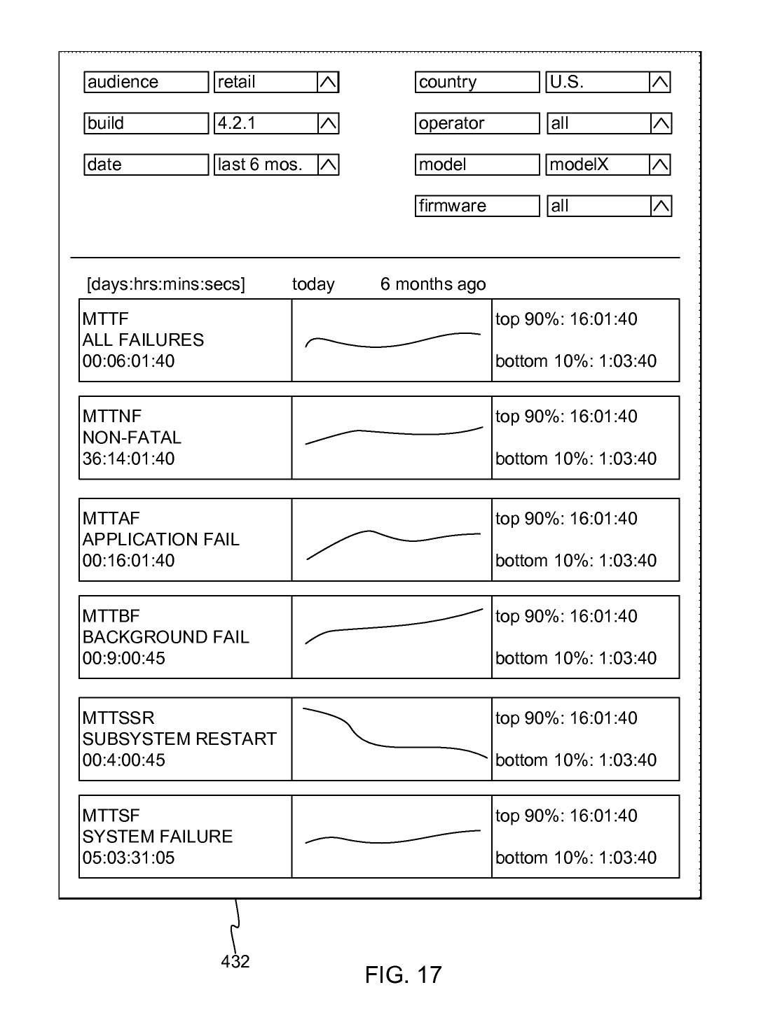

FIG. 17 shows an example of a user interface 432. An upper area of the user interface 432 includes interface elements for setting parameters that together specify a set of devices. The tool 440 sends the parameters to the control system 105. The control system 105 returns the corresponding MTTF values, perhaps for multiple MTTF types such as MTTAF and MTTSF. The MTTF values are displayed, perhaps in graph form, and possibly features of the dataset are also derived and displayed.

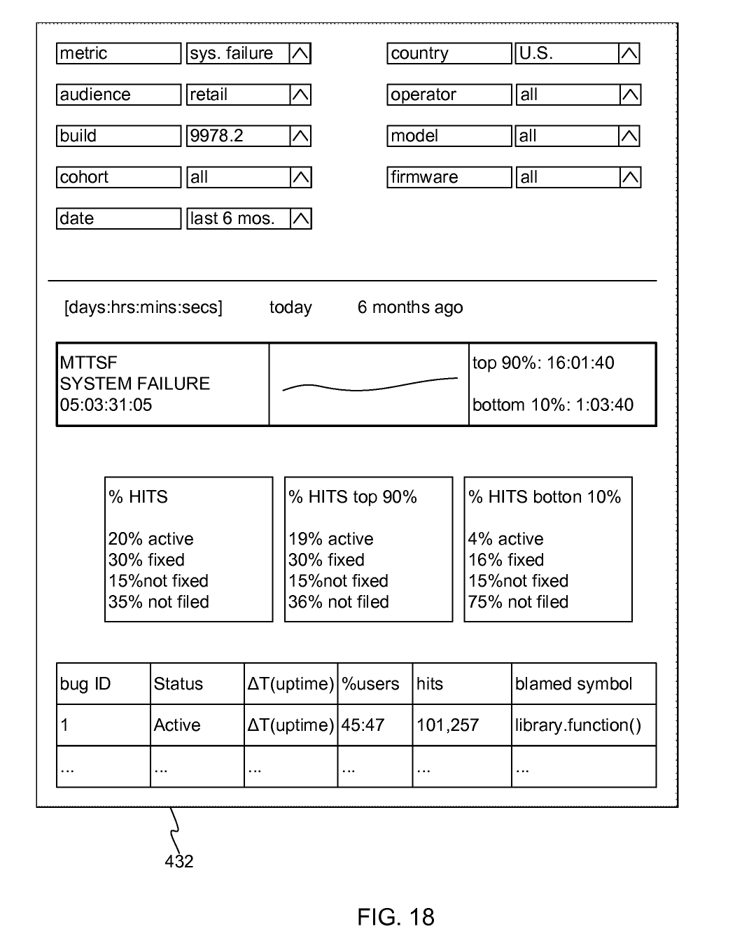

FIG. 18 shows another user interface 432. In addition to parameter settings, the user interface 432 provides detail about a particular type of MTTF selected by a user. For example, if a particular MTTF is selected through the user interface shown in FIG. 17, the user interface of FIG. 18 is displayed. In short, an MTTF type can be selected by the user as another parameter that defines the dataset being displayed. And, selection of an MTTF type can invoke a display of detail about the failure type, such as related bugs, which bugs contributed to the MTTF value, degree of contribution of particular bugs to the MTTF value, which implicated bugs affect the most devices, which software elements are most relevant to the MTTF value, and so on.

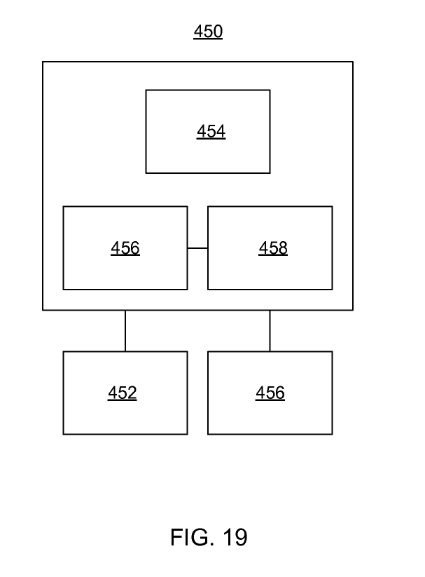

FIG. 19 shows details of a computing device 450 on which embodiments described above may be implemented. The technical disclosures herein are sufficient information for programmers to write software to run on one or more of the computing devices 450 to implement any of features or embodiments described in the technical disclosures.

The computing device 450 may have a display 452, a network interface 454, as well as storage 456 and processing hardware 458, which may be a combination of any one or more: central processing units, graphics processing units, analog-to-digital converters, bus chips, Field-programmable Gate Arrays (FPGAs), Application-specific Integrated Circuits (ASICs), Application-specific Standard Products (ASSPs), or Complex Programmable Logic Devices (CPLDs), etc. The storage 456 may be any combination of magnetic storage, static memory, volatile memory, etc. The meaning of the term “storage”, as used herein does not refer to signals or energy per se, but rather refers to physical apparatuses, possibly virtualized, including physical media such as magnetic storage media, optical storage media, memory devices, etc., but not signals per se. The hardware elements of the computing device 450 may cooperate in ways well understood in the art of computing. In addition, input devices may be integrated with or in communication with the computing device 450. The computing device 450 may have any form factor or may be used in any type of encompassing device. The computing device 450 may be in the form of a handheld device such as a smartphone, a tablet computer, a gaming device, a server, a rack-mounted or backplaned computer-on-a-board, a system-on-a-chip, or others.

### CONCLUSION

Embodiments and features discussed above can be realized in the form of information stored in volatile or non-volatile computer or device readable media. This is deemed to include at least media such as optical storage (e.g., compact-disk read-only memory (CD-ROM)), magnetic media, flash read-only memory (ROM), or any current or future means of storing digital information. The stored information can be in the form of machine executable instructions (e.g., compiled executable binary code), source code, bytecode, or any other information that can be used to enable or configure computing devices to perform the various embodiments discussed above. This is also deemed to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method of providing failure data, the method performed by a computing device comprised of storage hardware and processing hardware, the method comprising:
executing software on the device;
monitoring for failures of the software to determine corresponding failure times;
monitoring a state of the device to determine respective state-change times of the state changes;
based on the failure times and the state-change times or other information derived therefrom, for consecutive second time periods, computing respective second failure records, each second failure record comprising a second count and a second state duration of the corresponding second time period; and
transmitting the second failure records via a network to a control system.

2. A method according to claim 1, further comprising:
based on the failure times and the state-change times, for consecutive first time periods, computing respective first failure records, each first failure record comprising a first count and a first state duration of the corresponding first period.

3. A method according to claim 2, wherein the second failure records are computed from the other information, and wherein the other information comprises the first failure records.

4. A method according to claim 3, wherein a second failure record corresponds to a second time period, and wherein the method further comprises computing the second failure record by combining two consecutive first failure records that correspond to the second time period.

5. A method according to claim 2, wherein the first failure records are not sent to the control system.

6. A method according to claim 1, wherein the control system computes a mean time to failure value for the device based on the second failure records.

7. A method according to claim 1, wherein the state corresponds to active use of the computing device, and wherein the state-change times comprise times for which it was determined that the computing device started being used by a user and times for which it was determined that the computing device stopped being used by the user.

8. A method according to claim 1, wherein the state corresponds to uptime of the computing device and the state-change times comprise times corresponding to, or comprising, times at which the computing device was powered on and/or booted.

9. A computing device comprising:
storage hardware;
processing hardware;
agent software stored on the storage hardware and configured to be executed by the processing hardware and configured to perform a process when executed by the processing hardware, wherein when executed the process will:
periodically compute first mean time to fail (MTTF) statistics for a failure type that occurs on the computing device;
periodically compute second MTTF statistics by combining respective pluralities of the first MTTF statistics; and
periodically transmit the second MTTF statistics via a network to a collection service.

10. A computing device according to claim 9, wherein the MTTF statistics comprise durations of active use and/or uptime of the computing device.

11. A computing device according to claim 9, wherein the MTTF statistics comprises statistics for a plurality of types of MTTF, the types of MTTF comprising two or more of: mean active use time to failure, mean uptime to failure, mean time to system failure, meantime to background failure, mean time to application failure, mean time to non-fatal failure, and mean time to all failures.

12. A computing device according to claim 9, wherein the MTTF statistics comprise respective failure counts, and wherein the process when executed will compute MTTF counts for respective failure types by counting occurrences of first failure event types that correspond to a first failure type and by counting occurrences of second failure event types that correspond to a second failure type.

13. A computing device according to claim 12, wherein the MTTF statistics comprise durations of uptimes of the computing device and/or durations of active usage of the computing device.

14. A computing device according to claim 12, wherein the MTTF statistics comprise durations of active usage of the computing device, and wherein the agent software comprises an activity monitor that when executed will monitor for occurrences of predefined actions on the computing devices and computes the durations of active usage according to the predefined actions.

15. A method performed by one or more computer servers that comprise a control system, the method comprising:
receiving MTTF statistics pushed to the control system via a network by respective devices that computed the MTTF statistics based on failure events on the devices;
storing the MTTF statistics;
computing mean times to failure of the respective devices according to the stored MTTF statistics;
using the MTTF statistics to determine which of the devices to send pull requests for failure data, and sending the pull requests accordingly; and
receiving failure data from the devices to which the pull requests were sent.

16. A method according to claim 15, wherein multiple MTTF statistics from a same device for two respective time periods are used to compute an MTTF statistic for another time period that encompasses the two time periods.

17. A method according to claim 15, further comprising receiving a set of device characteristics inputted by a user, selecting a set of the devices on the basis of the devices having the characteristics, and computing mean times to failure for the set of devices according to the MTTF statistics of the set of devices.

18. A method according to claim 15, further comprising, for a set of the devices, for a sequence of times, computing respective collective mean times to failure of the set of devices as a whole, wherein a collective mean time to failure for a time in the sequence is computed by combining, from among the MTTF statistics of the devices in the set of devices, the MTTF statistics that correspond to the time in the sequence.

19. A method according to claim 18, further comprising displaying a user interface on a display, the user interface comprising a graph corresponding to the collective mean times to failure of the set of devices.

20. A method according to claim 15, wherein the received MTTF statistics further comprise time-computing statistics, the time-computing statistics, the method further comprising computing a MTTF value by using a time-computing statistic to lower a time between two failure events.
